(19) United States
(12) Patent Application Publication
(10) Pub. No.: US 2004/0037220 A1
(43) Pub. Date: Feb. 26, 2004

(54) Method of data transmission and a transmission and reception device in a distributed system

(76) Inventors: Andreas Junger, Reutlingen (DE); Rainer Moritz, Filderstadt (DE); Uwe Lueders, Reutlingen (DE); Jochen Schomacker, Reutlingen (DE); Berthold Elbracht, Reutlingen (DE); Jens Haensel, Leonberg (DE); Wolfgang Kostorz, Ludwigsburg (DE)

Correspondence Address: KENYON & KENYON, ONE BROADWAY, NEW YORK, NY, 10004, US

(21) Appl. No.: 10/320,196

(22) Filed: Dec. 16, 2002

(30) Foreign Application Priority Data
Dec. 14, 2001 (DE) 101 61 673.2

(51) Int. Cl. H04L 1/00

(52) U.S. Cl. 370/229; 370/395.7

(57) ABSTRACT

A method and a transmission and reception device for data transmission in a distributed system is described, in which a central control unit transmits data simultaneously to all decentralized control units in a broadcast mode. The preferred field of application is a decentralized system for environment sensors in a motor vehicle.

### FIELD OF THE INVENTION

The present invention relates to a method of data transmission and a transmission and reception device in a distributed system

### BACKGROUND INFORMATION

Decentralized systems having a plurality of decentralized control units and at least one central controller are known in many technological areas. German Published Patent Application No. 1 01 10 042.6 (not a prior publication) of Mar. 2, 2001 describes a distributed control and analysis system in a motor vehicle, where decentralized control units (such as sensors having appropriate electronics for control and/or analysis) are connected to a central control unit via a point-to-point link for data exchange. A data line connects the central control unit to each decentralized unit; both the decentralized control units and the central control unit are designed for transmitting and receiving signals (data). No appropriate configuration of the transmission and reception device or the appropriate method of data transmission between these components is described in the aforementioned document. The preferred application refers to the field of environment sensors in motor vehicles, in particular close range sensors such as radar sensor systems. In such a modular control unit design, effective, resource-efficient data communication is needed.

### SUMMARY OF THE INVENTION

The data load on the transmitter side and the transmitter software run time are reduced by the broadcast method for data transmission from the central control unit to the decentralized control units described below for a point-to-point interface. Particularly advantageous effects are obtained in use in a distributed system for environment sensors in a motor vehicle, in which, in addition to the broadcast function, there is also the option of specifically addressing decentralized control units using appropriate commands. In this manner, specific decentralized control units are activated, which results in a substantial reduction in mutual interference effects, in particular in the use of close range sensors (e.g., radar sensors). In this respect, the possibility of synchronizing all decentralized control units is particularly advantageous, because the broadcast function allows the simultaneous transmission of information to all decentralized control units.

The possibility of simultaneously transmitting the data to be transmitted from the transmitting control unit to all or a group of selected decentralized control units using a single command is particularly advantageous. There is also the possibility of providing individual decentralized units with information using other commands.

A transmission device, preferably an ASIC module, situated in the central control unit, by means of which the above-mentioned functions may be performed is particularly advantageous. In a particularly advantageous manner, this module also represents a module for receiving information from the decentralized control units; thus it simultaneously assumes functions associated with the data transmission from a decentralized control unit to the central control unit.

### BRIEF DESCRIPTION OF THE DRAWINGS

FIG. 1 shows a schematic diagram of a decentralized control system using the example of the preferred application of an environment sensor system, such as a close range sensor system (e.g., radar sensors).

FIG. 2 shows the details of the interface between the central control unit and the decentralized control units, a preferred embodiment of the interface module of the central control unit being shown in greater detail.

### DETAILED DESCRIPTION

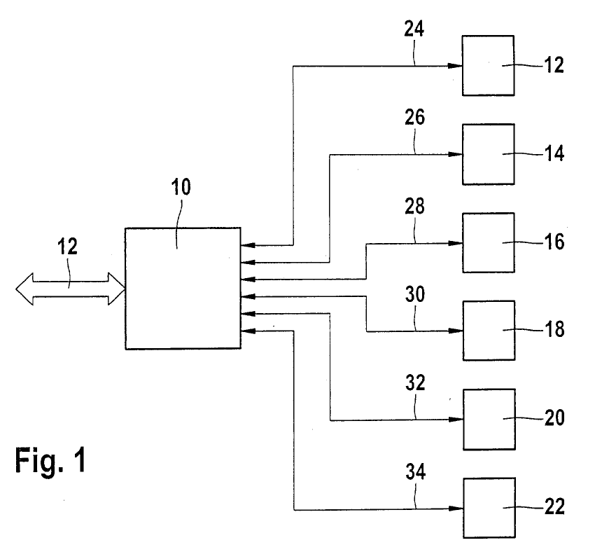

FIG. 1 shows a schematic diagram of a decentralized control system having a central control unit 10, which may be connected to other control units via a data communication system 12. In the example shown, a total of six decentralized control units 12, 14, 16, 18, 20, 22 are connected to central control unit 10 by point-to-point links. A bidirectionally operated interface 24, 26, 28 30, 32, 34 is provided between the central control unit and each decentralized control unit. In the preferred embodiment, this interface is a current-based dual wire interface. Data is exchanged between the central control unit and the decentralized control units via the particular interface, preferably the central control unit both transmitting data to and receiving data from the decentralized control units, and each decentralized control unit transmitting data to and receiving data from the central control unit.

Environment sensing, using radar, infrared or ultrasound sensors, lasers, or video cameras, for example, in motor vehicles represents a preferred field of application. These sensors and thus the decentralized control units are located on the outside of the vehicle, for example, in the bumpers, on the vehicle side, while the central control unit is mounted at a central location, for example, in the vehicle passenger compartment. Thus this is a system having distributed, intelligent components, i.e., components provided with at least one processor. Depending on the application, more or less decentralized control units may be provided. In addition, the procedure described in the following may also be used with any other interface between two control units where data is to be exchanged placing the least possible load on the interface and the components involved. The application is not restricted to environment sensing in motor vehicles, but may also be used in other decentralized systems in motor vehicles, for example, brake systems, engine control systems, etc. or in non-automotive systems.

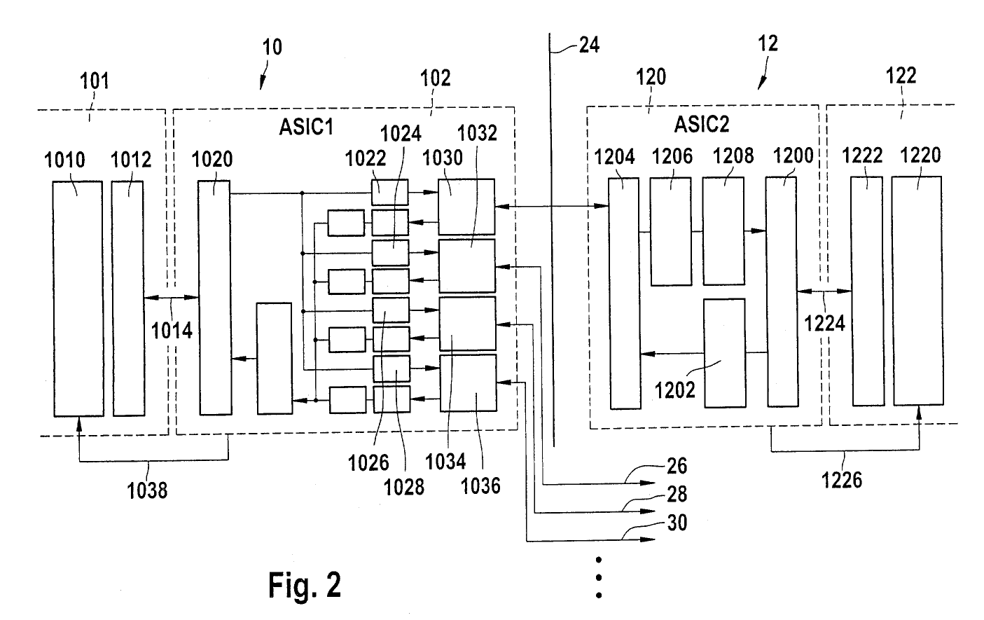

FIG. 2 shows the interface-specific components of central control unit 10 and of a selected decentralized control unit 12 in greater detail. Interfaces 26, 28, 30 to additional decentralized control units are also indicated.

Central control unit 10 is essentially composed of a computer core 101 and an interface module 102 (ASIC1), while the decentralized control unit has an interface module 120 (ASIC2) and a computer core 122. An interface 24, preferably implemented as a current-based dual wire interface, is located between the two interface modules. In a similar manner, interfaces are provided between interface module 102 at the central control unit and additional decentralized control units, which each have a module corresponding to module 120 as receivers and transmitters.

Computer core 101 of central control unit 10 includes a computer 1010 and an SPI interface 1012, which is connected to an SPI interface 1020 of interface module 102 via a data line 1014. Interface module 102 has transmit memories 1022, 1024, 1026 and 1028 for the transmission direction, which are each connected to current-based dual wire interface (PAS1 through PAS4) 1030, 1032, 1034, and 1036, respectively. The data to be transmitted is output as a command by microcomputer 1010 to module 102 via the SPI interface and temporarily stored in the respective transmit memory. The command contains indication of whether the data is to be transmitted to all decentralized units, a group thereof, or to a single unit. The data is written into the memory accordingly. Then the stored data is sent from these memories via the particular interface to the decentralized control unit its receive memories are free. In the receive direction, data from a decentralized control unit is received by interface module 102 and stored in at least one receive memory E1, E2 (for each receive channel). The data received is then read from this at least one memory by the computer via a multiplexer MUX and the SPI interface. For this purpose, the presence of data to be read is signaled by the interface module to the computer via link line 1038.

The particular decentralized control unit is designed in a similar manner. Computer core 122 provided there also includes a microcomputer 1220 and an SPI interface 1222, which is connected to corresponding interface 1200 of interface module 120 via a data line 1224. Also in this case a receive memory 1202 is provided for the receive direction. The data loaded into memory 1202 by the microcomputer via the SPI interface is then transmitted via a current-based dual wire interface 1204 to the central control unit, provided its receive memories are free. On the receive side, current-based dual wire interface 1204 is connected to at least one receive memory 1206, 1208, where the data received is stored. The received, temporarily stored data is read by microcomputer 1220 via the SPI interface. For this purpose, microcomputer 1220 receives appropriate information from module 120 via data link 1226. The other decentralized control units are designed in a similar manner, in particular with respect to interface module 120.

The above-named elements are hardware elements whose implementation is known per se. The size and number of memories are selected according to the application. In one exemplary application, one transmit memory and two receive memories, having a length of one byte each, have been found adequate. It is to be noted that the SPI interface and/or the PAS interface have their own intermediate memories in one embodiment.

The procedure described below in modules 102 and 120 is hard wired in the modules.

A broadcast mode, by means of which microcomputer 1010 of central control unit 10 outputs data provided with the “transmit to all” identification to interface module 102 via its SPI interface is provided for data transmission between the central control unit and the decentralized control units. Interface module 102 reads this data into all transmit memories of all interfaces and then transmits the data to all control units simultaneously via the interface. Thus the microcomputer of the central control unit is capable of writing a data set into all interfaces to the decentralized control units using an SPI command. The data is transmitted simultaneously. Synchronizing measures of the distributed systems, for example, may be derived from this simultaneity, because simultaneity of the transmission operation provides the distributed units with a time basis.

Instead of the “transmit to all” command, the “transmit to Group 1” or “transmit to Group 2” command is provided in another exemplary embodiment, so that the data is written into the transmit memory of the selected preset groups.

There is also the possibility of a command by means of which the computer is capable of transmitting data to a single selected decentralized control unit, so that the corresponding data is stored in interface module 102 only in the transmit register provided for this decentralized control unit and is transmitted only to this decentralized control unit. Thus it is possible to activate specific individual decentralized control units; for example, a sequence of triggering or activation operations may be established.

In a preferred embodiment, the commands are structured so that an identifier describing the transmission mode is appended to the transmitted data.

The data is received by the central control unit so that the data received by the particular decentralized control unit via the interface is stored in the associated at least one receive register and then sequentially read by the microcomputer via the SPI interface using the multiplexer. For this purpose, the microcomputer receives the information from module 102 that data has been received in one of the receive registers.

The possibility for the computer of the central control unit to transmit data with the command “transmit to all” or “transmit to Group x” results in a substantial reduction in the data load on the interface and in the running time of its software.

The preferred application of the procedure described above is in combination with an environment sensor system, in particular close range sensors such as, for example, a 24 GHz radar platform for multifunction applications, with a current-based dual wire interface being provided between the central control unit and the decentralized control units within a star-shape serial point-to-point interface.

The above-described procedure is also used with the aforementioned advantages in other applications having a point-to-point wiring for distributed systems.

What is claimed is:

1. A method of data transmission in a decentralized system including at least one central control unit and at least two decentralized control units that are connected via a data interface, comprising:
transmitting data from the at least one central control unit to all of the at least two decentralized control units, wherein:
the at least one central control unit and the at least two decentralized control units are connected by point-to-point wiring, data being simultaneously transmitted by the at least one central control unit to one of all of the at least two decentralized control units and a predefined group thereof using a command.

2. The method as recited in claim 1, wherein:
the command is an SPI command.

3. The method as recited in claim 1, further comprising:
using the command to temporarily store a data block when data is transmitted to one of all of the at least two decentralized control units and the predefined group thereof, in a transmit memory associated with a particular receiver, the command being transmitted simultaneously to all receivers.

4. The method as recited in claim 1, wherein:
the data interface between the at least one central control unit and the at least two decentralized control units includes a current-based dual wire interface.

5. The method as recited in claim 1, wherein:
data received by one of the at least two decentralized control units are temporarily stored in at least one receive memory and are read out via a multiplexer.

6. The method as recited in claim 1, further comprising:
storing another data block identified as having another command for transmitting to a single receiver in a corresponding transmit memory; and
transmitting the other data block.

7. A transmission and reception device in a distributed system, the transmission and reception device being a component of a central control unit of the distributed system, comprising:
a first interface via which a connection to a microcomputer of the central control unit is achieved; and
a predefined number of other interfaces via which connections to decentralized control units are achieved, wherein:
at least one transmit memory is associated with each decentralized unit, and
data are loaded, using a command, into one of all transmit memories and a predefined number thereof for simultaneous transmission.

8. The device as recited in claim 7, wherein:
the first interface is an SPI interface, and
each of the interfaces to the decentralized control units is a current-based dual wire interface.

9. The device as recited in claim 7, wherein:
the device is an interface module, the interface module including at least one receive memory for each receive channel from the decentralized control units, in which received data are temporarily stored, the interface module also including a multiplexer via which data to be read out are transmitted to the microcomputer of the central control unit.

10. The device as recited in claim 7, wherien:
the distributed system is a distributed system for an environment sensor system of a motor vehicle.

11. The device as recited in claim 7, wherein:
the device is an ASIC.

12. The device as recited in claim 7, wherein:
the command is appended to data to be sent as an identifier.
